(19) United States
(12) Patent Application Publication
(10) Pub. No.: US 2023/0064905 A1
(43) Pub. Date: Mar. 2, 2023

(54) SEMICONDUCTOR DEVICE

(71) Applicant: RENESAS ELECTRONICS CORPORATION, Tokyo (JP)

(72) Inventor: Takayuki OOTANI, Tokyo (JP)

(21) Appl. No.: 17/878,256

(22) Filed: Aug. 1, 2022

(30) Foreign Application Priority Data
Sep. 1, 2021 (JP) 2021-142815

(51) Int. Cl. G06F 11/16; G06F 11/20

(52) U.S. Cl. CPC G06F 11/1675; G06F 11/2035; G06F 2201/85

(57) ABSTRACT

When one of CPUs that perform a lock step operation fails and the failure type is an SW failure, the semiconductor device copies information held by an SR and a GR of the CPU operating normally to the CPU with the SW failure, thereby continuing a process without stopping the lock step operation. On the other hand, when the failure type is an HW failure, the failed CPU is stopped to continue the process with only the normal CPU.

### CROSS-REFERENCE TO RELATED APPLICATIONS

The disclosure of Japanese Patent Application No. 2021-142815 filed on Sep. 1, 2021 including the specification, drawings and abstract is incorporated herein by reference in its entirety.

### BACKGROUND

This disclosure relates to a semiconductor device, and is a technology effectively applied to, for example, a semiconductor device configured to perform the lock step operation in which a plurality of CPU cores execute the same process in parallel.

As a semiconductor device, there is an in-vehicle processor for which high reliability is required. As a technology for improving the reliability, the in-vehicle processors sometimes adopt the lock step operation in which two CPU (Central Processing Unit) cores are operated in the same cycle and the two CPU cores are made to execute the same process. As a proposal for the semiconductor device configured to perform the lock step operation, there are related techniques.

### [Patent Document 1] Japanese Unexamined Patent Application Publication No. 2016-35626

### SUMMARY

In the semiconductor device disclosed in Japanese Unexamined Patent Application Publication No. 2016-35626, when one of the two CPU cores that perform the lock step operation fails, the failed CPU is stopped and the process is continued with only the normal CPU. Namely, since the CPU core in which the failure has been detected is stopped regardless of the failure type (hardware (HW) failure or software (SW) failure), the semiconductor device of Patent Document 1 has the problem that the lock step operation cannot be continued and the reliability cannot be improved.

An object of this disclosure is to provide the technology capable of switching whether the process is continued in the lock step operation or the failed CPU is stopped and the process is continued with only the normal CPU, based on the failure type.

Other objects and novel features will be apparent from the description of this specification and accompanying drawings.

An outline of the typical embodiment in this disclosure will be briefly described as follows.

A semiconductor device according to an embodiment includes: a calculation unit including a first CPU and a second CPU that perform a lock step operation; and a sequence control circuit, wherein each of the first CPU and the second CPU includes: a system register (SR) and a general-purpose register (GR); a replica diagnostic circuit configured to check whether the corresponding CPU is operating correctly; an input port configured to input held information of the SR and the GR; an output port configured to output held information of the SR and the GR; and a self-diagnostic circuit configured to determine a failure type, wherein the calculation unit includes a lock step control circuit configured to perform a comparison operation in a lock step operation, wherein the sequence control circuit includes: a failed CPU determination circuit configured to determine a failed CPU based on information from the replica diagnostic circuit and perform rollback process; a software (SW) failure determination circuit configured to determine a failure type based on information from the self-diagnostic circuit; a shift control circuit configured to copy held information of the SR and the GR of a normal CPU operating normally to the SR and the GR of a failed CPU with a failure; and an LS resumption control circuit configured to resume the lock step operation, and wherein when the SW failure determination circuit determines that the failure type of the failed CPU is an SW failure, the sequence control circuit copies the held information of the SR and the GR of the normal CPU, which is one of the first CPU and the second CPU, to the SR and the GR of the failed CPU determined to have the SW failure, which is the other of the first CPU and the second CPU, thereby continuing a process of the lock step operation.

By the semiconductor device according to the embodiment described above, when one of CPUs that perform the lock step operation fails and if the failure is the SW failure, the information held by the SR and the GR of the CPU operating normally is copied to the CPU with the SW failure, whereby the process can be continued without stopping the lock step operation. As a result, the reliability of the semiconductor device can be improved.

### BRIEF DESCRIPTION OF THE DRAWINGS

FIG. 1 is a flow diagram showing a control method of a semiconductor device according to the embodiment.

FIG. 2 is a block diagram showing an entire chip of a semiconductor device according to the first example.

FIG. 3 is an explanatory diagram of a configuration example of a CPU block and a configuration example of a sequence control circuit in FIG. 2.

FIG. 4 is an explanatory diagram of an operation of the CPU block and the sequence control circuit in FIG. 3.

FIG. 5 is an explanatory diagram of a configuration example and a copy operation of an SR and a GR.

FIG. 6 is an explanatory diagram of a dead period of a lock step comparison.

FIG. 7 is an explanatory diagram of a configuration example of a CPU block and a configuration example of a sequence control circuit according to the second example.

FIG. 8 is a diagram showing a configuration example of an SR and a GR according to the second example.

FIG. 9 is an explanatory diagram of a copy operation of the SR and the GR in FIG. 8.

FIG. 10 is an explanatory diagram of a configuration example of a CPU block and a configuration example of a sequence control circuit according to the third example.

FIG. 11 is an explanatory diagram of an operation of the CPU block and the sequence control circuit in FIG. 10.

FIG. 12 is an explanatory diagram of a configuration example and a copy operation of an SR and a GR in FIG. 10.

FIG. 13 is an explanatory diagram of a configuration example of a CPU block and a configuration example of a sequence control circuit according to the fourth example.

FIG. 14 is an explanatory diagram of an operation of the CPU block and the sequence control circuit in FIG. 13.

FIG. 15 is an explanatory diagram of a configuration example and a copy operation of an SR and a GR according to the fourth example.

FIG. 16 is an explanatory diagram of a configuration example of two CPU core blocks and a configuration example of a sequence control circuit according to the fifth example.

FIG. 17 is a diagram showing an operation of a lock step operation resumption control according to the eighth example.

FIG. 18 is a diagram showing a configuration example of an interconnect according to the ninth example.

FIG. 19 is an explanatory diagram of a configuration example of an interconnect block and a configuration example of a sequence control circuit according to the ninth example.

FIG. 20 is an explanatory diagram of an operation of the interconnect block and the sequence control circuit in FIG. 19.

FIG. 21 is an explanatory diagram of a configuration example of a CPU block and a configuration example of a sequence control circuit according to the tenth example.

FIG. 22 is an explanatory diagram of an operation of the CPU block and the sequence control circuit in FIG. 21.

FIG. 23 is an explanatory diagram of a configuration example and a copy operation of an SR and a GR.

### DETAILED DESCRIPTION

Hereinafter, the embodiment, the examples, and the modifications will be described with reference to drawings. However, in the following description, the same components are denoted by the same reference characters and the repetitive description thereof will be omitted in some cases. The drawings may be shown schematically as compared with an actual aspect in order to make the description clearer, but they are mere examples and do not limit the interpretation of the present invention.

First, the failure type and the like will be described.

Failures of a semiconductor device typically include a hardware (HW) failure and a software (SW) failure. The HW failure occurs due to fatal damage such as the damage to the circuit itself. In the SW failure, the semiconductor device, the memory device, or the like temporarily malfunctions for some reason (for example, noise or cosmic rays). In the case of the SW failure, the circuit itself of the semiconductor device is not damaged, and thus it returns to the normal state by restarting (or resetting) or data repair (ECC (Error-correcting code, error correction): SEC (single error correction)).

Until now, the occurrence probability of SW failure was lower than that of HW failure. This was because the size of the semiconductor device was relatively large, the power supply voltage was high, and the operating frequency was low. In addition, the probability of malfunction due to some noise was low.

Next, failures in an in-vehicle semiconductor device will be described.

In recent years, the functions required for in-vehicle semiconductor devices (AI (Artificial Intelligence)/machine learning, etc.) have been increasing, and miniaturization and performance improvement of in-vehicle semiconductor devices have been advancing. Here, the miniaturization means microfabrication in the manufacturing technology of semiconductor devices, reduction of power supply voltage of semiconductor devices, and the like. The performance improvement means improvement of the operating frequency of semiconductor devices, complication of the circuit of semiconductor devices, and the like. Under the circumstance in which it is certain that technologies related to human life such as autonomous driving will be incorporated into in-vehicle semiconductor devices in the future, the influences of SW failures cannot be ignored considering the preparation to satisfy the demand for the higher safety level required for in-vehicle semiconductor devices.

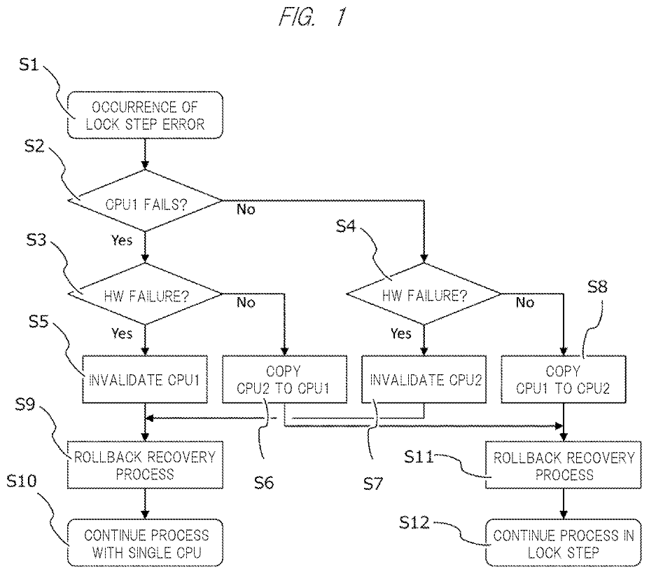

FIG. 1 is a flow diagram showing a control method of a semiconductor device according to the embodiment. As shown in FIG. 1, the control method of the semiconductor device corresponds to the control method in the case where an error occurs in a calculation unit including a first CPU core (hereinafter referred to as CPU1) and a second CPU core (hereinafter referred to as CPU2) that perform the lock step operation.

Step S1: A calculation error occurs in the calculation unit including the CPU1 and the CPU2 that perform the lock step operation.

Step S2: It is determined whether the cause of the calculation error is a failure of the CPU1 or a failure of the CPU2. If the cause of the calculation error is not the failure of the CPU2 but the failure of the CPU1 (Yes), the flow proceeds to step S3. If the cause of the calculation error is not the failure of the CPU1 but the failure of the CPU2 (No), the flow proceeds to step S4.

Step S3: It is determined whether the cause of the calculation error is the HW failure of the CPU1 or the SW failure of the CPU1. If the cause of the calculation error is not the SW failure of the CPU1 but the HW failure of the CPU1 (Yes), the flow proceeds to step S5. If the cause of the calculation error is not the HW failure of the CPU1 but the SW failure of the CPU1 (No), the flow proceeds to step S6.

Step S4: It is determined whether the cause of the calculation error is the HW failure of the CPU2 or the SW failure of the CPU2. If the cause of the calculation error is not the SW failure of the CPU2 but the HW failure of the CPU2 (Yes), the flow proceeds to step S7. If the cause of the calculation error is not the HW failure of the CPU2 but the SW failure of the CPU2 (No), the flow proceeds to step S8.

Step S5: Since the CPU1 has the HW failure, the CPU1 is invalidated (set to a non-operating state). Thereafter, the flow proceeds to step S9.

Step S6: Since the CPU1 has the SW failure, the value of a general-purpose register of the CPU2 and the value of a system register of the CPU2 are copied to a general-purpose register and a system register of the CPU1. As a result, preparations for making the CPU1 and the CPU2 perform the lock step operation are completed. Thereafter, the flow proceeds to step S11. Here, the value of the general-purpose register and the value of the system register can be regarded as the content information held inside the CPU core.

Step S7: Since the CPU2 has the HW failure, the CPU2 is invalidated (set to a non-operating state). Thereafter, the flow proceeds to step S9.

Step S8: Since the CPU2 has the SW failure, the value of the general-purpose register of the CPU1 and the value of the system register of the CPU1 are copied to the general-purpose register and the system register of the CPU2. As a result, preparations for making the CPU1 and the CPU2 perform the lock step operation are completed. Thereafter, the flow proceeds to step S11.

Step S9: Rollback recovery process is executed. Thereafter, the flow proceeds to step S10.

Step S10: The CPU with the HW failure (CPU1 or CPU2) is stopped, and process is continued with only the normal single CPU (CPU2 or CPU1).

Step S11: Rollback recovery process is executed. Thereafter, the flow proceeds to step S12.

Step S12: Process is continued by making the CPU1 and the CPU2 perform the lock step operation.

In the manner described above, when one of the CPU1 and the CPU2 that perform the lock step operation fails, if the failure is the SW failure (repairable), the content information (the value of the general-purpose register and the value of the system register) held by the CPU core (CPU1 or CPU2) that is operating normally is copied to the general-purpose register and the system register of the CPU core (CPU2 or CPU1) with the SW failure. As a result, the process can be continued without stopping the lock step operation. This makes it possible to improve the reliability of the semiconductor device.

Hereinafter, configuration examples (first to eighth examples) of the semiconductor device capable of implementing the control method of the semiconductor device of FIG. 1 will be described with reference to the drawings. In the description of the first to eighth examples and the tenth example, the “failed CPU” means a CPU with the SW failure, not a CPU with the HW failure, unless otherwise specified.

### First Example

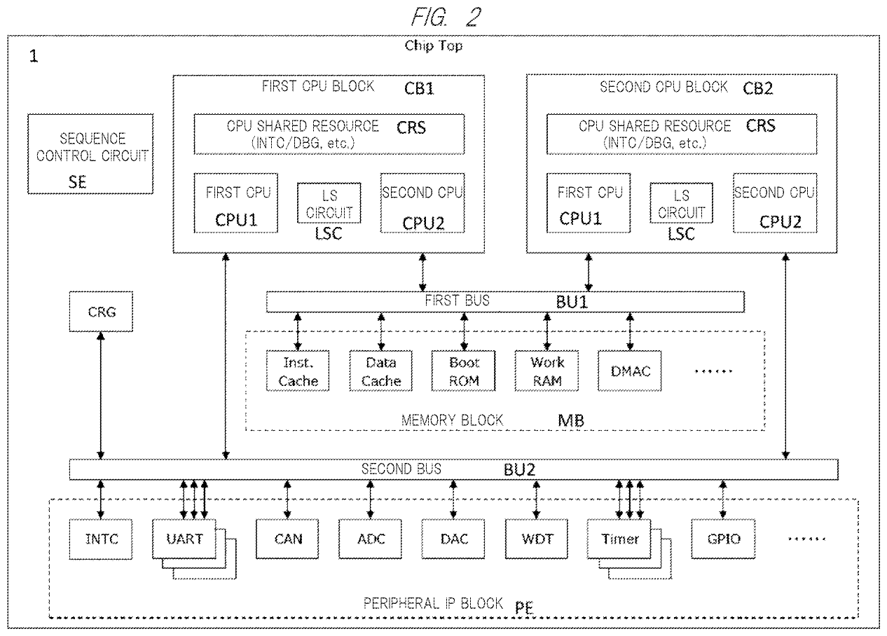

FIG. 2 is a block diagram showing an entire chip of a semiconductor device according to the first example. The semiconductor device 1 is an in-vehicle data processor formed on a semiconductor chip such as single crystal silicon by a known CMOS manufacturing method. Further, the semiconductor device 1 is configured to be able to perform the lock step operation in which a plurality of CPU cores are made to execute the same process in parallel.

As shown in FIG. 2, the semiconductor device 1 includes a first CPU block CB1, a second CPU block CB2, a sequence control circuit SE, a memory block MB, a peripheral IP block PE, a first bus BU1, a second bus BU2, and a clock reset generator CRG. Each of the first CPU block CB1 and the second CPU block CB2 is a calculation unit.

Each of the first CPU block CB1 and the second CPU block CB2 includes, for example, a first CPU core (hereinafter referred to as CPU1), a second CPU core (hereinafter referred to as CPU2), a lock step control circuit (LS circuit) LSC for controlling the lock step operation of the CPU1 and the CPU2, a CPU shared resource CR, and the like. The CPU shared resource CR includes, for example, an interrupt control circuit INTC, a debug control circuit DBG, and the like. Each of the first CPU block CB1 and the second CPU block CB2 is connected to the first bus BU1 and the second bus BU2. The lock step control circuit LSC has a comparison circuit for comparing the calculation result of the CPU1 and the calculation result of the CPU2. When the calculation result of the CPU1 and the calculation result of the CPU2 match, the lock step control circuit LSC determines that there is no failure in the CPU1 and the CPU2, and performs the control to continue the lock step operation. On the other hand, when the calculation result of the CPU1 and the calculation result of the CPU2 do not match (in the case of mismatch), the lock step control circuit LSC determines that there is a failure in the CPU1 or the CPU2, and performs the control to stop the lock step operation.

The memory block MB is connected to the first bus BU1 and includes a plurality of memory devices and memory control circuits. The plurality of memory devices and memory control circuits include, for example, an instruction cache (Inst. Cache), a data cache (Data Cache), a boot memory (Boot ROM: Read only memory), a work memory (work RAM: random access memory), a dynamic memory access controller (DMAC), and the like.

The peripheral IP block PE is connected to the second bus BU2 and includes a plurality of peripheral circuits. The plurality of peripheral circuits include, for example, an interrupt control circuit (INTC: Interrupt Controller), a serial communication circuit (UART: Universal Asynchronous Receiver/Transmitter), a CAN (Controller Area Network) controller (CAN), an analog-to-digital conversion circuit (ADC), a digital-to-analog conversion circuit (DAC), a watchdog timer (WDT), multiple timer circuits (Timer), a general-purpose input/output circuit (GPIO: General-purpose input/output), and the like. Since the operations and functions of the circuits of the memory block and the peripheral IP block shown in FIG. 2 are well known, detailed description thereof will be omitted.

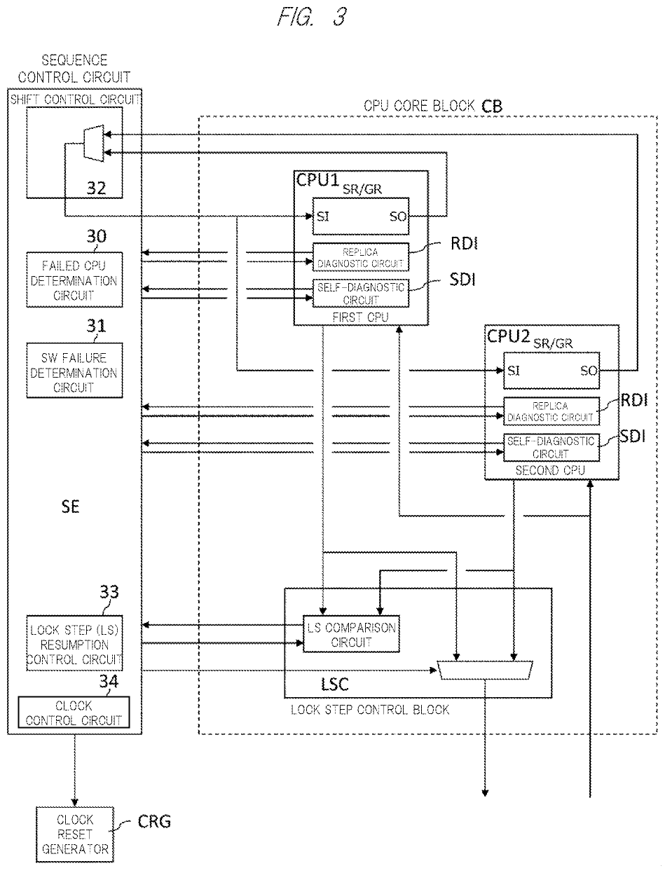

FIG. 3 is an explanatory diagram of a configuration example of the CPU block and a configuration example of the sequence control circuit in FIG. 2. FIG. 3 illustrates the CPU core block, the sequence control circuit, and the clock reset control circuit.

The CPU core block CB corresponds to the first CPU block CB1 or the second CPU block CB2 in FIG. 2, and includes the first CPU core (hereinafter, CPU1), the second CPU core (hereinafter, CPU2), and the lock step control block LSC (corresponding to the LS circuit LSC in FIG. 2). Each of the CPU1 and the CPU2 has a system register (hereinafter referred to as SR) and a general-purpose register (hereinafter referred to as GR). A value of the GR and a value of the SR can be regarded as content information held by the CPU core (CPU1 or CPU2). The lock step control block LSC is a circuit that performs a lock step comparison operation in the lock step operation.

The sequence control circuit SE is used when copying the held information of the SR and the GR. The clock reset generator CRG generates a clock signal and a reset signal.

Each of the CPU1 and the CPU2 includes a replica diagnostic circuit RDI that checks whether the corresponding CPU core is operating correctly, a serial input port (SI) and a serial output port (SO) that input and output the held information of the SR and the GR, and a self-diagnostic circuit SDI for determining the failure type.

The sequence control circuit SE includes a failed CPU determination circuit 30 that determines a failed CPU based on the information from the replica diagnostic circuit RDI and performs rollback process, an SW failure determination circuit 31 that determines a failure type based on the information from the self-diagnostic circuit SDI, a shift control circuit 32 that copies the held information of the SR and the GR from the normal CPU to the failed CPU, an LS resumption control circuit 33 that controls the timing to resume the lock step (LS) operation, and a clock control circuit 34 that controls the stop and resumption of the clock. Here, the normal CPU means a CPU core that is operating normally, and the failed CPU means a CPU core that has the SW failure.

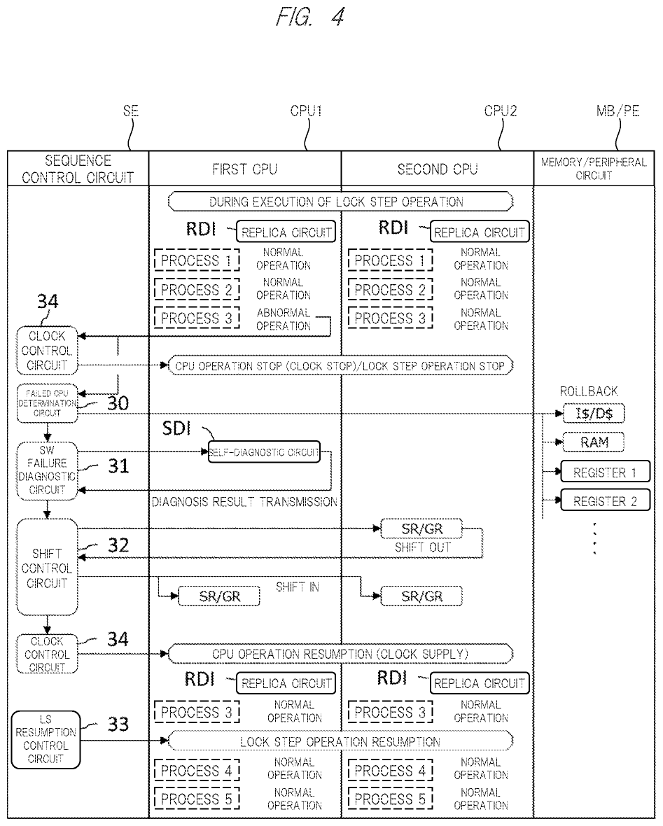

FIG. 4 is an explanatory diagram of an operation of the CPU block and the sequence control circuit in FIG. 3.

It is assumed that the first CPU (CPU1) and the second CPU (CPU2), which are performing the lock step operation, execute the process 1, the process 2, and the process 3, respectively.

The replica diagnostic circuit RDI checks the execution of each process 1, 2, and 3, and determines the normal operation of the CPU 1 and CPU 2 or the abnormal operation of the CPU 1 and CPU 2 for each process 1, 2, and 3.

Here, for example, it is assumed that, when the CPU1 executes the process 3, the replica diagnostic circuit RDI detects an abnormal operation and notifies the sequence control circuit SE.

When the abnormal operation is notified, the clock control circuit 34 inside the sequence control circuit SE stops the clock, thereby stopping the operation of the CPU1 and the CPU2. At the same time, the lock step operation is stopped.

When the abnormal operation is notified, the failed CPU determination circuit 30 inside the sequence control circuit SE determines the CPU in which the abnormal operation is detected, executes the rollback process for the memory block MB and the peripheral IP block PE, and notifies the SW failure determination circuit 31 of the failed CPU information.

When the failed CPU information is notified, the SW failure determination circuit 31 instructs the self-diagnostic circuit RDI of the failed CPU (here, CPU1) to start diagnosis.

When the start of diagnosis is instructed, the self-diagnostic circuit SDI executes a predetermined test sequence set in advance for each functional block in order to determine the SW failure or the HW failure. Then, the self-diagnostic circuit SDI determines the SW failure or the HW failure, and notifies the sequence control circuit SE of the determination result. When the diagnosis result is the SW failure, the sequence control circuit SE notifies the shift control circuit 32 of the result. When the diagnosis result is the HW failure, the sequence control circuit SE continues the process with only the normal CPU.

Hereinafter, in the first example, the operation will be described on the assumption that the diagnosis result is the SW failure.

When the SW failure is notified, the SW failure determination circuit 31 notifies the shift control circuit 32 of the determination result. When the SW failure is notified, the shift control circuit 32 starts the shift control for the system register (SR) and the general-purpose register (GR).

The shift control circuit 32 reads the held information of the system register (SR) and the general-purpose register (GR) from the SO port of the normal CPU (here, CPU2). Thereafter, the read content information is written to the system register (SR) and the general-purpose register (GR) from each SI port of the CPU1 and the CPU2.

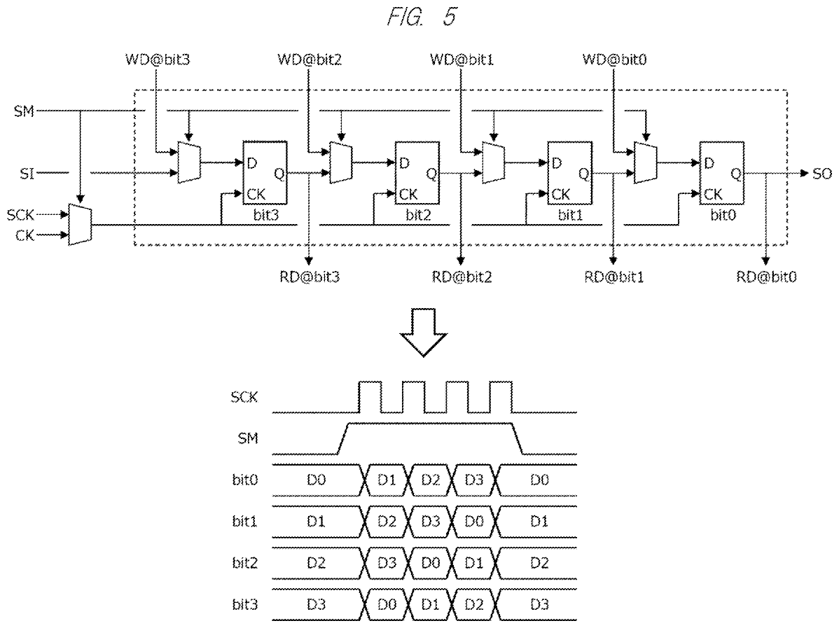

FIG. 5 is an explanatory diagram of a configuration example and a copy operation of the SR and the GR. Here, for the sake of simplifying the description, the bit length configuration of the register (SR or GR) is expressed in 4 bits, but the actual bit length of the SR and the GR is configured in 32 bits or 64 bits.

The SR and the GR include a write data (WD) port for writing to the register during normal operation, a read data (RD) port for reading from the register during normal operation, a shift mode (SM) port for controlling the shift operation from the shift control circuit, and an SI port and an SO port for copying the register information.

The shift control circuit 32 sets the SM port to the high level “H”, so that the data input from the SI port is sequentially set to each bit in accordance with the shift clock SCK.

As shown in FIG. 4, when the copying process of the SR and the GR is completed, the shift control circuit 32 notifies the clock control circuit 34 of the completion of copying.

When the completion of copying is notified, the clock control circuit 34 starts supplying the clock CK to the CPU1 and the CPU2.

After starting the clock supply, the LS resumption control circuit 33 resumes the lock step operation by using the dead period (the period in which invalid information is output) information of the lock step comparison.

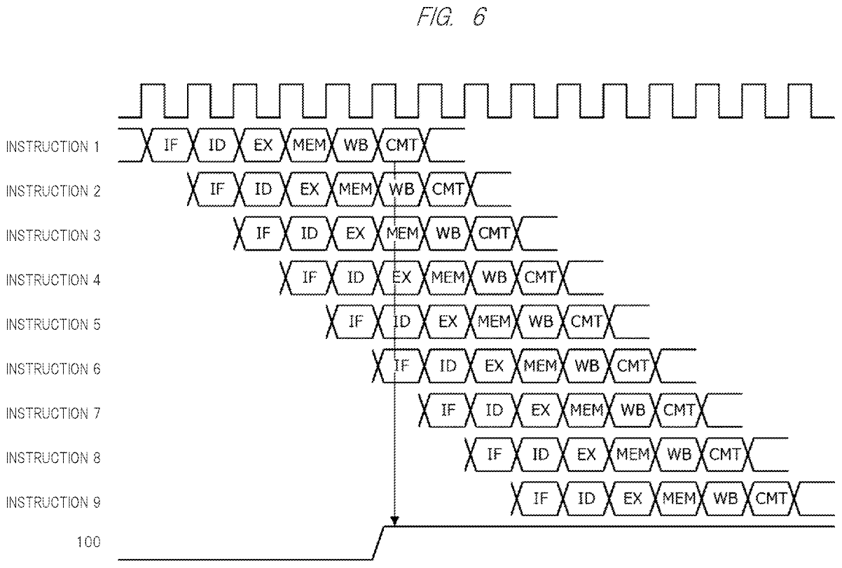

Here, FIG. 6 shows the dead period (the period in which invalid information is output) of the lock step comparison. The period until the first instruction (in this case, instruction 1) after resuming the clock supply reaches the commit stage (CMT) of the pipeline is defined as an indefinite period, and the timing to resume the lock step operation is controlled by a signal 100 that becomes the high level “H” after the instruction 1 reaches the CMT. In FIG. 6, IF indicates instruction fetch, ID indicates instruction decode, EX indicates execution, MEM indicates memory access, and WB indicates register write back.

According to the first example, the following effects can be obtained.

(1) By mounting the self-diagnostic circuit SDI, it is possible to determine the failure type for a CPU determined as a failed CPU.

(2) By mounting the shift control circuit 32, it is possible to copy the information of the SR and the GR from a normal CPU to a failed CPU.

(3) By mounting the LS resumption control circuit 33, the lock step control circuit can resume the comparison operation of the lock step operation without causing a pseudo error.

(4) By controlling the above new function by the sequence control circuit SE, when a CPU failure occurs during the execution of the lock step operation and if the failure is the SW failure (repairable failure), the CPU can resume the execution while continuing the lock step operation by copying the information of the SR and the GR from the normal CPU to the failed CPU, so that the reliability of the semiconductor device can be improved.

(5) Although Patent Document 1 is similar to the first example in that “the CPU resumes the execution”, only the normal CPU alone executes the process and the failed CPU is stopped, so that the lock step operation cannot be continued in Patent Document 1. In this respect, the first example has an advantage.

### Second Example

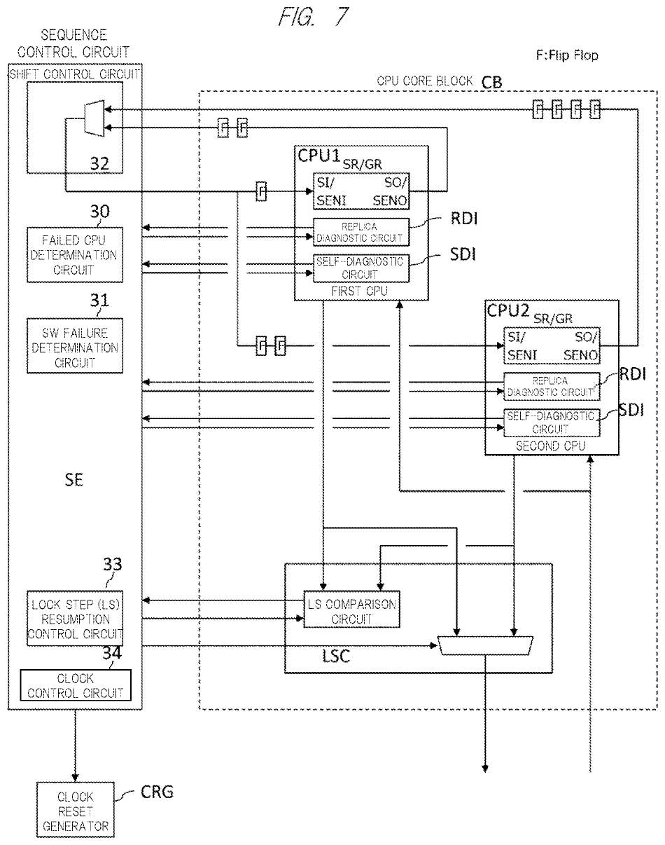

Next, the second example will be described with reference to FIG. 7 to FIG. 9.

FIG. 7 is an explanatory diagram of a configuration example of a CPU block and a configuration example of a sequence control circuit according to the second example. The configuration example of the second example (FIG. 7) is different from the configuration example of the first example (FIG. 3) in that the configuration example of the second example (FIG. 7) is provided with a signal SENI and a signal SENO and one or more flip-flop circuits (F) in addition to the configuration example of the first example (FIG. 3). The signal SENI indicates valid data of SI and the signal SENO indicates valid data of SO, and they are provided in the SR and the GR of the first CPU (CPU1) and the second CPU (CPU2). The one or more flip-flop circuits (F) are provided on the path between the output of the shift control circuit 32 and the SI and on the path between the SO and the input of the shift control circuit 32. Since the other configurations and operations of the second example are the same as those of the first example, duplicate description will be omitted.

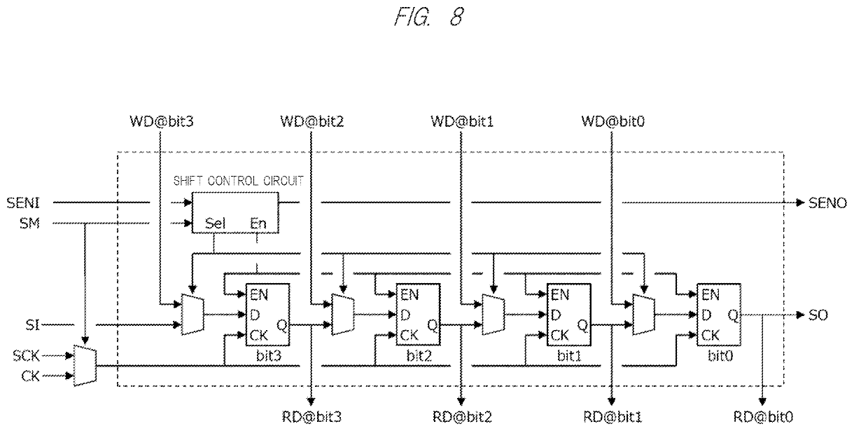

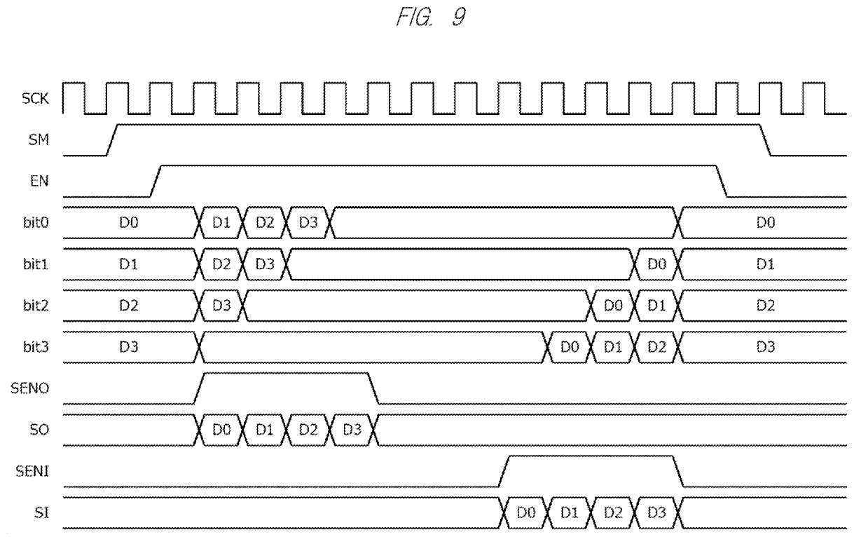

FIG. 8 is a diagram showing a configuration example of the SR and the GR according to the second example. FIG. 9 is an explanatory diagram of a copy operation of the SR and the GR in FIG. 8.

In the configuration example of the SR and the GR shown in FIG. 8, the signal SENI and the signal SENO indicating the validity of the respective input/output data (SI/SO) of the system register (SR) and the general-purpose register (GR) are input and output as pairs. As shown in FIG. 9, the serial output data of the SO port is valid for a period when the signal SENO is at the high level “H”. The serial input data of the SI port is valid for a period when the signal SENI is at the high level “H”.

According to the second example, the following effects can be obtained.

In the first example, the data output from the SO port needs to be input to the SI port in the same cycle. Therefore, there is a possibility that copying cannot be performed only at a frequency of about several MHz to several tens MHz depending on the physical arrangement restrictions of the CPU1 and the CPU2 (long distance, etc.). In order to solve this problem, by mounting the flip-flop circuits (F) on the paths of the SI port and the SO port, the frequency at the time of copying can be improved.

However, since the timing is cut by the flip-flop circuit (F), the invalid data held by the flip-flop circuit (F) on the path and the held information of the SR and the GR output from the SI port and the SO port become indistinguishable from each other. In order to solve this problem, by transferring the signal SENI and the signal SENO indicating the validity of the respective data of the SI port and SO port in pairs, the correct (valid) held information of the SR and the GR can be set to the registers (SR, GR).

### Third Example

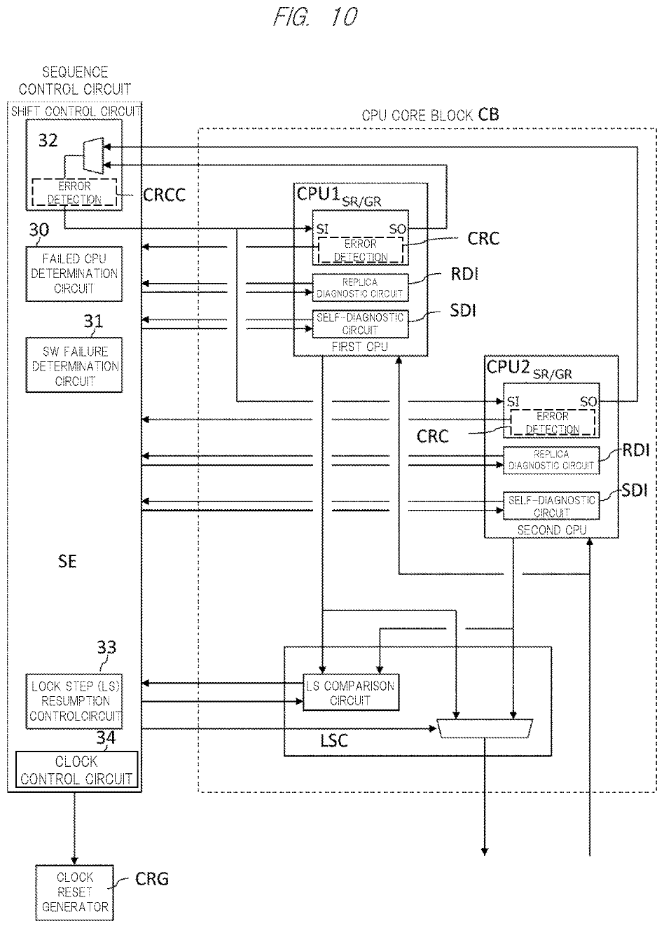

Next, the third example will be described with reference to FIG. 10 to FIG. 12.

FIG. 10 is an explanatory diagram of a configuration example of a CPU block and a configuration example of a sequence control circuit according to the third example. The configuration example of the third example (FIG. 10) is different from the configuration example of the first example (FIG. 3) in that the configuration example of the third example (FIG. 10) is provided with a cyclic redundancy check circuit (CRC circuit) CRC for detecting error information of the information of the system register (SR) and the general-purpose register (GR). Specifically, the cyclic redundancy check circuit CRC is provided in each of the CPU1 and the CPU2. The first cyclic redundancy check circuit CRC generates error detection information (here, CRC-1) for the held information of the SR and the GR, and outputs the error detection information after adding it to the end of the information of the SR and the GR. The first cyclic redundancy check circuit CRC also has a function of performing a check with the information of the SR and the GR and the error detection information. Further, the second cyclic redundancy check circuit CRCC is provided in the shift control circuit 32. The second cyclic redundancy check circuit CRCC performs a check with the information of the SR and the GR input to the failed CPU and the error detection information, and notifies the sequence control circuit SE of the result. Since the other configurations of the third example are the same as the configurations of the first example, duplicate description will be omitted.

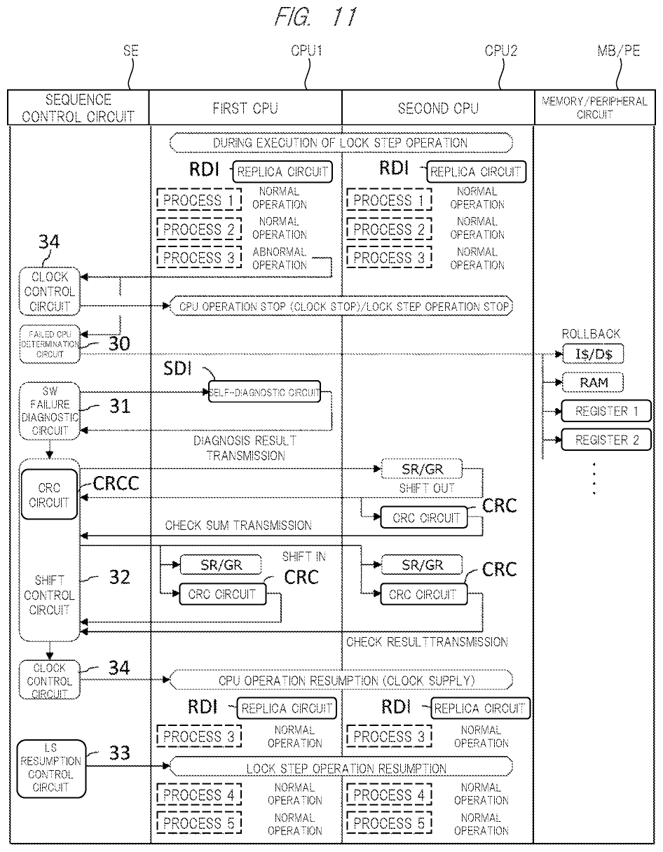

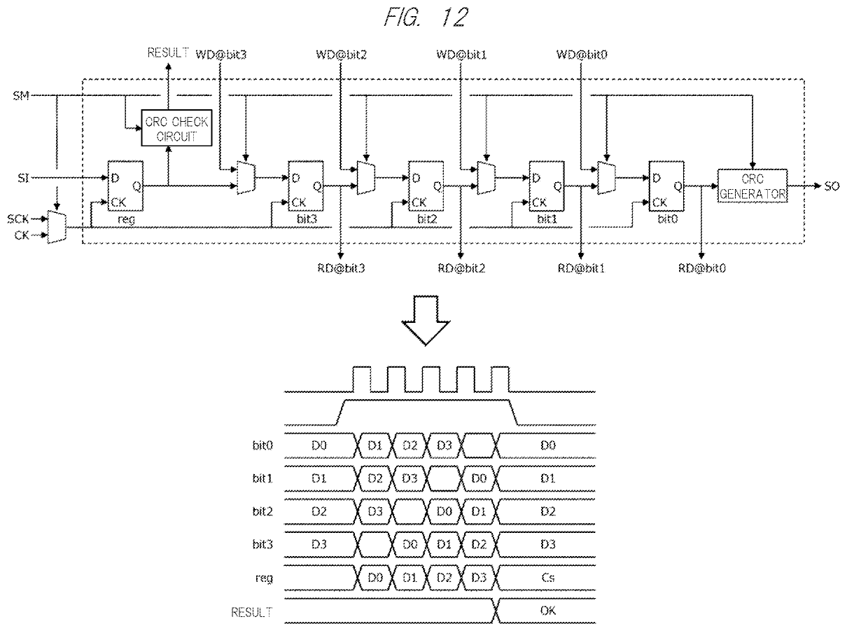

FIG. 11 is an explanatory diagram of an operation of the CPU block and the sequence control circuit in FIG. 10. FIG. 12 is an explanatory diagram of a configuration example and a copy operation of the SR and the GR in FIG. 10. The basic operation of the third example is the same as the operation of the first example. The operation of the third example is different from the operation of the first example in that the cyclic redundancy check circuit CRC generates error detection information (here, CRC-1) for the information of the SR and the GR output from the normal CPU and outputs the error detection information after adding it to the end of the information of the SR and the GR. Another difference is that the cyclic redundancy check circuit CRCC performs a check with the information of the SR and the GR input to the failed CPU and the error detection information, and notifies the sequence control circuit SE of the result, whereby the sequence control circuit SE determines whether the information of the SR and the GR has been transferred correctly.

Although it is also possible to execute the error information check only in the failed CPU that finally receives the information, the third example adopts the configuration in which the check is also executed in the sequence control circuit SE. However, it is assumed that the sequence control circuit SE performs only the check and does not generate new error detection information.

According to the third example, the following effects can be obtained.

In the first example, there is no method for confirming whether the information of the SR and the GR has been copied correctly. Therefore, if a change in data occurs during copying, a lock step error will occur after the CPU resumes the process. On the other hand, in the third example, since the error detection information is added to the information of the SR and the GR to be copied, it becomes possible to confirm whether the copying process has been executed correctly, and the quality at the time of copying the information of the SR and the GR can be improved.

### Fourth Example

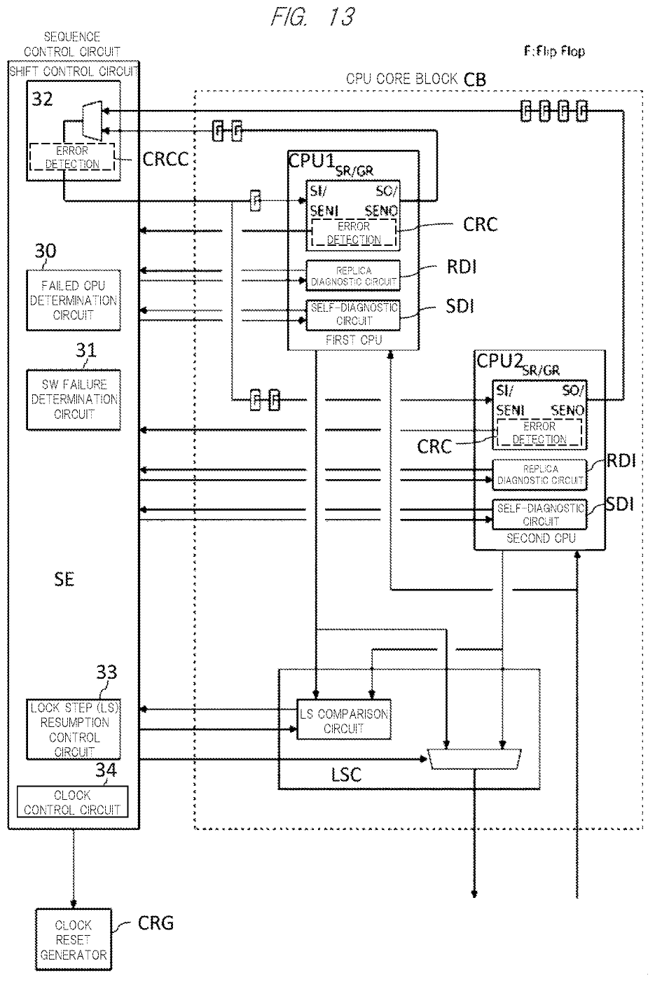

Next, the fourth example will be described with reference to FIG. 13 to FIG. 15.

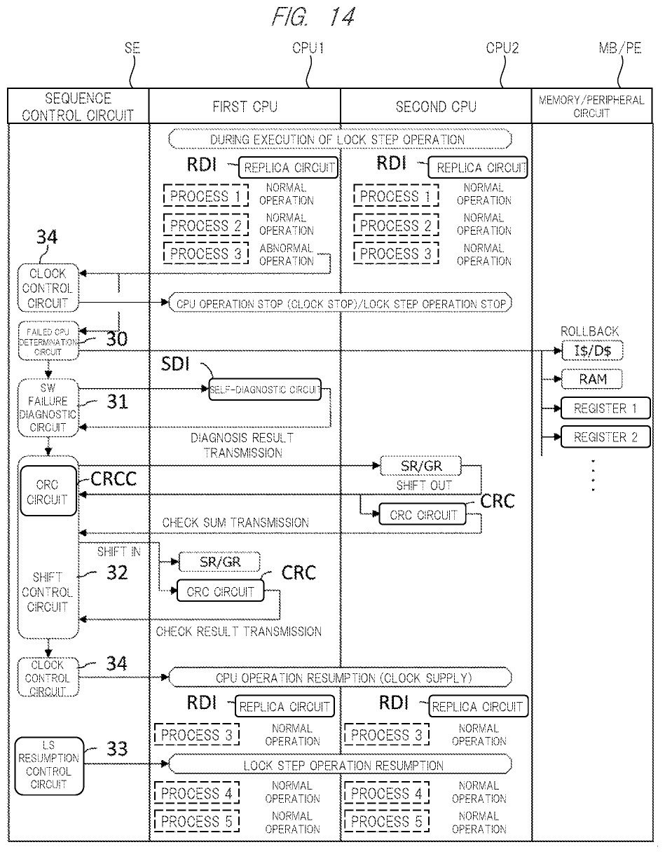

FIG. 13 is an explanatory diagram of a configuration example of a CPU block and a configuration example of a sequence control circuit according to the fourth example. FIG. 14 is an explanatory diagram of an operation of the CPU block and the sequence control circuit in FIG. 13. The configuration example of the fourth example (FIG. 13) is different from the configuration example of the first example (FIG. 3) in that the configuration example of the fourth example (FIG. 13) is provided with the following (1) to (3).

(1) The signal SENI indicating valid data of the SI port and the signal SENO indicating valid data of the SO port are provided in the SR and the GR of the first CPU (CPU1) and the second CPU (CPU2).

(2) One or more flip-flop circuits (F) are provided on the path between the output of the shift control circuit and the SI and on the path between the SO and the input of the shift control circuit.

(3) A CRC (Cyclic Redundancy Check) circuit for detecting error information of the information of the system register (SR) and the general-purpose register (GR) is provided. Namely, the configuration example of the fourth example (FIG. 13) adopts both the configuration example of the second example and the configuration example of the third example.

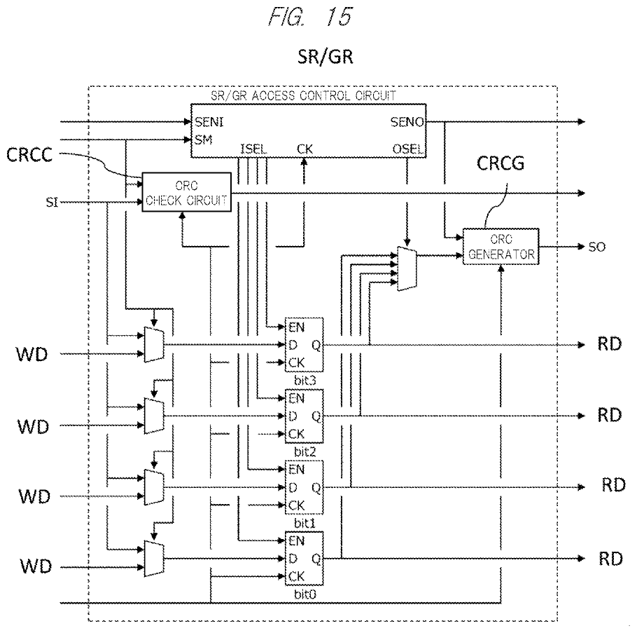

The configuration example of the system register (SR) and the general-purpose register (GR) of the fourth example adopts a configuration different from the configuration example of the system register (SR) and the general-purpose register (GR) adopted in the first to third examples. FIG. 15 is an explanatory diagram of a configuration example and a copy operation of the SR and the GR according to the fourth example.

As shown in FIG. 15, the SR and the GR include a write data (WD) port for writing to the register during normal operation, a read data (RD) port for reading from the register during normal operation, a shift mode (SM) port for controlling the shift operation from the shift control circuit, a serial input (SI) port and a serial output (SO) port for copying the register information, a signal SENI indicating valid data of the SI port, a signal SENO indicating valid data of the SO port, a shift control circuit for controlling the data of the SI port and the data of the SO port, a CRC check circuit CRCC, and a CRC generator CRCG.

The operation of the fourth example is shown in FIG. 14. The basic operation of the fourth example is the same as the operation of the third example. The operation of the fourth example is different from the operation of the third example in that the information of the SR and the GR and the error detection information are output from the normal CPU, but only the failed CPU receives the information and the SR and the GR of the normal CPU maintain the state where the CPU is stopped.

According to the fourth example, the following effects can be obtained.

In the first to third examples, both the normal CPU and the failed CPU receive the information of the SR and the GR output from the normal CPU. On the other hand, in the fourth example, by selectively outputting the information of the SR and the GR of the normal CPU, the state at the time of stopping can be maintained.

### Fifth Example

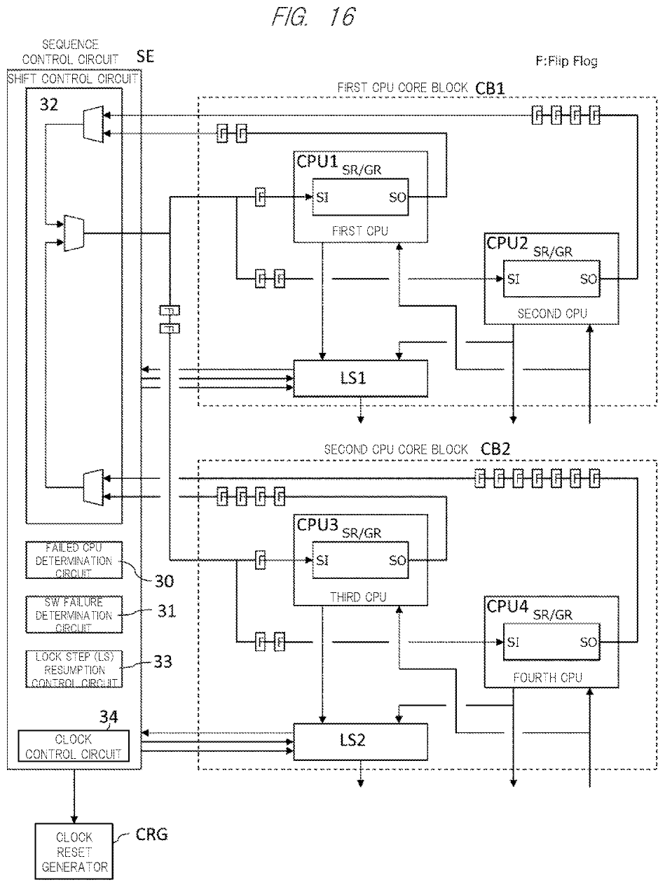

Next, the fifth example will be described with reference to FIG. 16.

FIG. 16 is an explanatory diagram of a configuration example of two CPU core blocks and a configuration example of a sequence control circuit according to the fifth example.

In the fifth example, a first CPU core block CB1, a second CPU core block CB2, a sequence control circuit SE, and a clock reset generator CRG are illustrated. The first CPU core block CB1 includes a first CPU core (CPU1), a second CPU core (CPU2), and a first lock step control circuit unit (LS1). The second CPU core block CB2 includes a third CPU core (CPU3), a fourth CPU core (CPU4), and a second lock step control circuit unit (LS2). The sequence control circuit SE is used to copy the information of the system register (SR) and the general-purpose register (GR). The clock reset generator CRG generates a clock signal and a reset signal.

As the configuration of the first CPU core block CB1 and the configuration of the second CPU core block CB2, the configuration of the CPU core block CB of the second example or the fourth example can be adopted. As the configuration of the first CPU core block CB1 and the configuration of the second CPU core block CB2, the configurations of the CPU core block CB of the first and third examples are also conceivable, but they are impractical in consideration of the physical arrangement restrictions.

The difference between the operation of the fifth example and the operations of the first to fourth examples will be described. In the first to fourth examples, the information of the SR and the GR of the normal CPU is copied to the failed CPU in the same core block (CB1 or CB2). On the other hand, in the fifth example, the information of the SR and the GR of the normal CPU is copied to the SRs and the GRs of two CPUs (CPU1 and CPU2, or CPU3 and CPU4) in the different CPU core block (CB1 or CB2). For example, when it is assumed that the CPU1 of the first CPU core block CB1 is a normal CPU and the CPU2 of the first CPU core block CB1 is a failed CPU with the SW failure, the information of the SR and the GR of the CPU1 of the first CPU core block CB1 is copied to the SR and the GR of the CPU2 and the SRs and the GRs of the two CPU cores (CPU3, CPU4) of the second CPU core block CB2.

According to the fifth example, the following effects can be obtained.

In the fifth example, the target to which the information of the SR and the GR is copied is expanded to the CPUs in another core block. When a failure of the CPU2 occurs during the lock step operation, if the failure is the SW failure (repairable failure), the information of the SR and the GR of the normal CPU1 is copied not only to the SR and the GR of the failed CPU2 but also to the SRs and the GRs of the CPU3 and the CPU4, whereby the CPU1 to CPU4 can resume the execution while continuing the lock step operation of the CPU1 and the CPU2 and the lock step operation of the CPU3 and the CPU4, and the reliability of the semiconductor device can be improved.

### Sixth Example

A configuration in which the information to be copied is expanded as follows with respect to the first to fifth examples is also conceivable. The information to be copied can include the following information (1) to (4).

(1) Information of the system register (SR) and the general-purpose register (GR)

(2) Pipeline information

(3) Information of instructions and flags held in each pipeline stage

(4) State information in each pipeline stage

In the sixth example, by expanding the information to be copied, it becomes possible to effectively utilize the software resources until a failure occurs. Here, the information in the pipeline of the CPU is also regarded as a kind of software resource.

### Seventh Example

The information to be copied can include information of all FFs in the CPU1 and the CPU2.

In the seventh example, since the information of all FFs in the CPU can be copied, the control of resuming the lock step operation becomes unnecessary. Further, since the test system register of the lock step comparison circuit can be utilized by applying the configuration of the seventh example, the test quality at the time of power on can be improved.

### Eighth Example

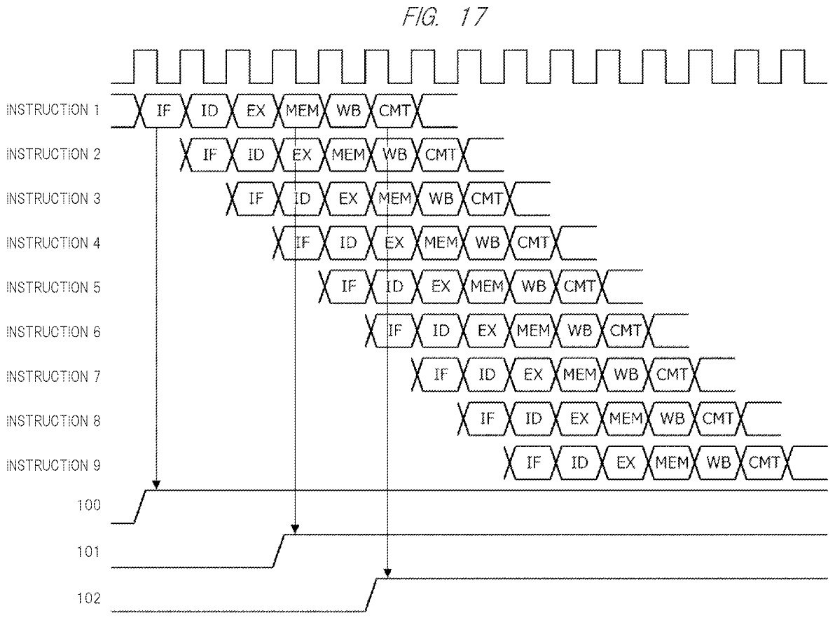

FIG. 17 is a diagram showing an operation of a lock step operation resumption control according to the eighth example.

A configuration in which the lock step operation resumption control is expanded as follows with respect to the first to fifth examples is also conceivable. The resumption of the lock step operation is controlled by the three signals 100, 101, and 102 that become the high level “H” as shown in FIG. 17. Interfaces to perform the lock step operation (comparison) are grouped for each pipeline stage (grouped into 3 in this example), and the lock step operation is resumed for the grouped interfaces as the first instruction after resumption advances through the pipeline.

Further, it is also possible to shorten the period until the lock step operation is resumed by combining the sixth example and the eighth example.

### Ninth Example

In the ninth example, the case where the interconnect is the target of the lock step will be described as an example of the case where the target of the lock step is other than the CPU. The configuration of the ninth example is different from the configuration of the first example in that the multiplexed parts that perform the lock step operation are not the CPU cores but the interconnects. Further, the operation of the ninth example is basically the same as the operation of the first example.

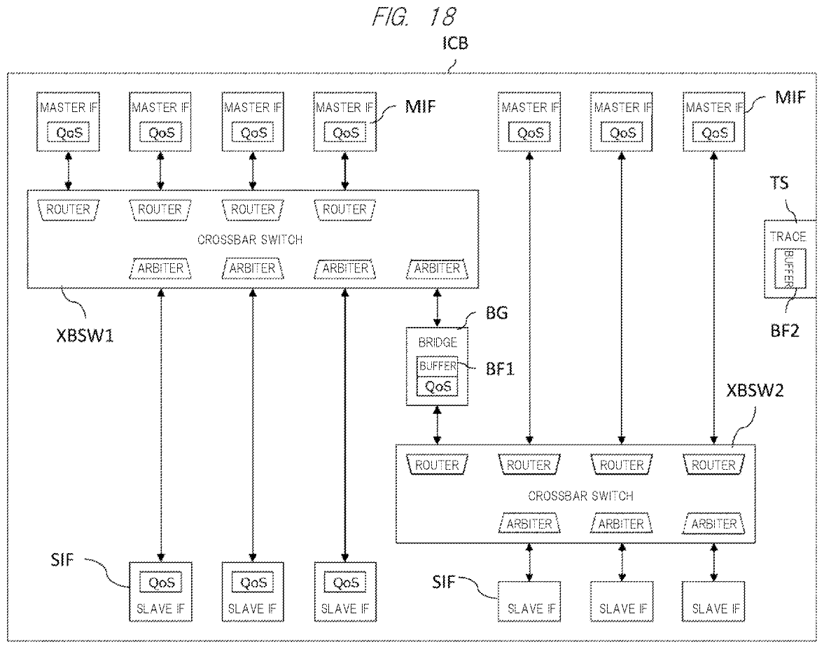

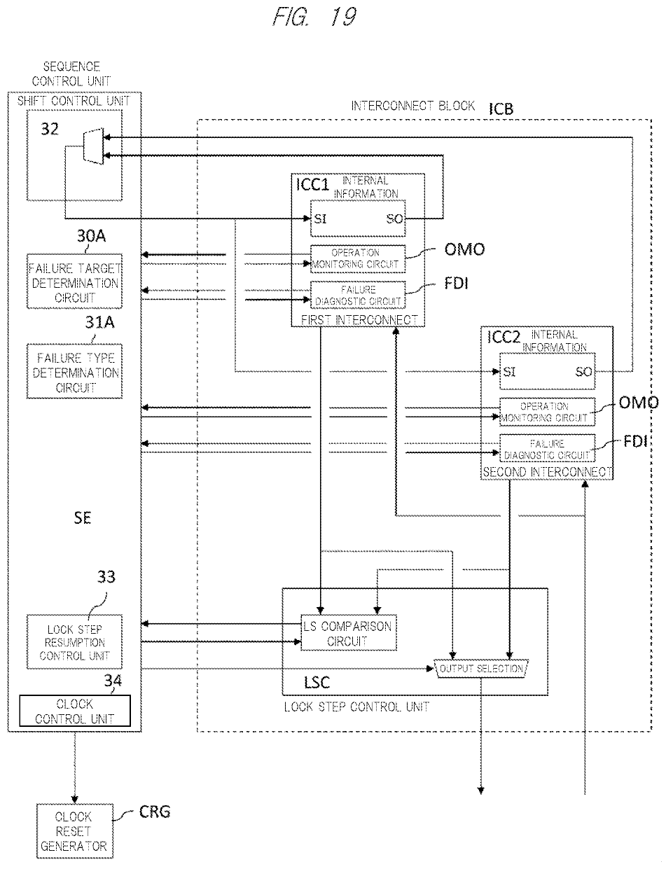

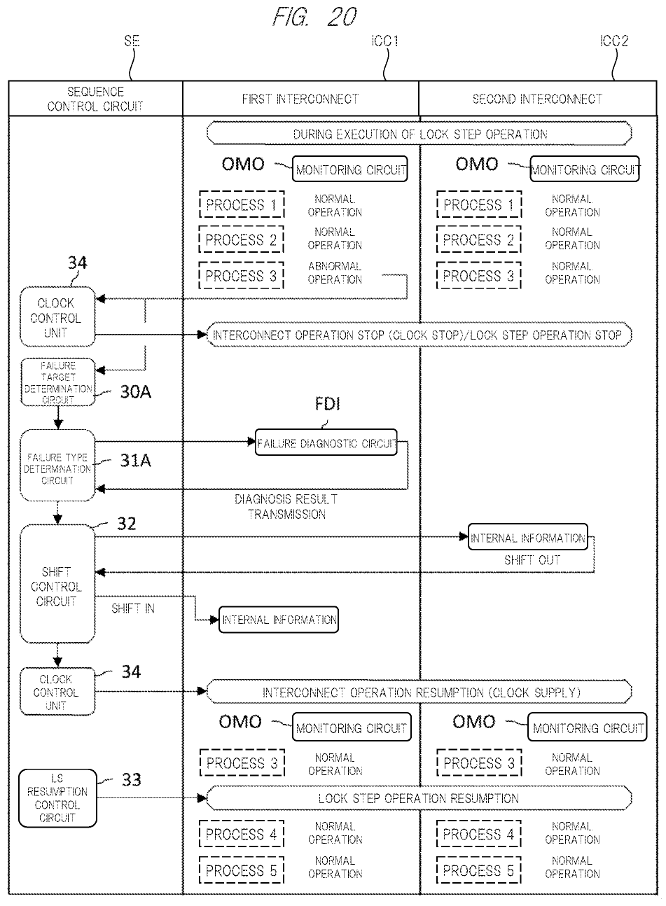

FIG. 18 is a diagram showing a configuration example of an interconnect according to the ninth example. FIG. 19 is an explanatory diagram of a configuration example of an interconnect block and a configuration example of a sequence control circuit according to the ninth example. FIG. 20 is an explanatory diagram of an operation of the interconnect block and the sequence control circuit in FIG. 19.

As shown in FIG. 18, an interconnect ICC can be composed of, for example, master interfaces MIF and slave interfaces SIF corresponding to various protocols, crossbar switches XBSW1 and XBSW2 which are responsible for routing by routers and arbitration by arbiters, QoS (Quality of Service) for monitoring and controlling the latency and throughput, a bridge BG which is coupled between the crossbar switches XBSW1 and XBSW2 and includes a buffer BF1 for holding the packet information in the interconnect ICC, a trace TC that includes a buffer BF2 for holding the information necessary for debugging and outputs the information necessary for debugging, and others.

FIG. 19 illustrates an interconnect block ICB, a sequence control circuit SE, and a clock reset generator CRG. The interconnect block ICB includes a first interconnect ICC1, a second interconnect ICC2, and a lock step control unit LSC. Each of the first interconnect ICC1 and the second interconnect ICC2 includes the interconnect ICC shown in FIG. 18, a serial input port (SI) and a serial output port (SO) for inputting/outputting internal information, an operation monitoring circuit OMO that monitors and checks whether the corresponding interconnect (ICC1, ICC2) is operating correctly, and a failure diagnostic circuit FDI that determines the failure type of the corresponding interconnect (ICC1, ICC2).

The sequence control circuit SE includes a failure target determination circuit 30A that determines a failed interconnect based on information from the operation monitoring circuit OMO and performs rollback process, a failure type determination circuit (or failure type diagnostic circuit) 31A that determines a failure type based on information from the failure diagnostic circuit FDI, a shift control circuit 32 that copies the internal information from the normal interconnect to the failed interconnect, an LS resumption control circuit 33 that controls the timing to resume the lock step (LS) operation, and a clock control circuit 34 for controlling the stop and the resumption of the clock. Here, the normal interconnect means an interconnect ICC that is operating normally, and the failed interconnect means an interconnect ICC that has the SW failure.

As shown in FIG. 20, it is assumed that the first interconnect ICC1 and the second interconnect ICC2, which are performing the lock step operation, execute the process 1, the process 2, and the process 3, respectively.

The operation monitoring circuit OMO checks the execution of each process 1, 2, and 3, and determines the normal operation of the ICC1 and the ICC2 or the abnormal operation of the ICC1 and the ICC2 for each process 1, 2, and 3.

Here, for example, it is assumed that, when the ICC1 executes the process 3, the operation monitoring circuit OMO detects an abnormal operation and notifies the sequence control circuit SE.

When an abnormal operation is notified, the clock control circuit 34 inside the sequence control circuit SE stops the clock, thereby stopping the operation of the ICC1 and the ICC2. At the same time, the lock step operation is stopped.

When the abnormal operation is notified, the failure target determination circuit 30A inside the sequence control circuit SE determines the ICC1 whose abnormal operation has been notified, and notifies the failure type determination circuit 31A of the failed interconnect information.

When the failed interconnect information is notified, the failure type determination circuit 31A instructs the failure diagnostic circuit FDI of the failed interconnect (here, ICC1) to start diagnosis.

When the start of diagnosis is instructed, the failure diagnostic circuit FDI executes a predetermined test sequence set in advance for each functional block in order to determine the SW failure or the HW failure. Then, the failure diagnostic circuit FDI determines the SW failure or the HW failure, and notifies the failure type determination circuit 31A of the diagnosis result. When the diagnosis result is the SW failure, the failure type determination circuit 31A notifies the shift control circuit 32 of the result. When the diagnosis result is the HW failure, the sequence control circuit SE continues the process with only the normal interconnect.

In the following, the operation will be described on an assumption of the case where the diagnosis result is the SW failure.

When the SW failure is notified, the failure type determination circuit 31A notifies the shift control circuit 32 of the determination result. When the SW failure is notified, the shift control circuit 32 starts the shift control of internal information for the serial input port (SI) and the serial output port (SO) that inputs/outputs internal information.

The shift control circuit 32 reads internal information from the SO port of the normal interconnect (here, ICC2).

Thereafter, the read internal information is written from each SI port of the ICC1 and the ICC2.

Thereafter, as shown in FIG. 20, when the copying process of the internal information is completed, the shift control circuit 32 notifies the clock control circuit 34 of the completion of copying.

When the completion of copying is notified, the clock control circuit 34 starts supplying the clock CK to the ICC1 and the ICC2.

After starting the clock supply, the LS resumption control circuit 33 resumes the lock step operation by using the dead period (the period in which invalid information is output) information of the lock step comparison.

A method of correcting an error by using ECC for packet information (address, data, etc.) handled by the interconnect has been known. However, the ECC can correct only the error of the data itself, and cannot repair failures such as routing/arbitration.

As shown in the ninth example, when one of the interconnects performing the lock step operation fails and the failure is the SW failure, the internal information held by the normally operating interconnect is copied to the interconnect with the SW failure, whereby the process can be continued without stopping the lock step operation. Accordingly, in the interconnects that are multiplexed in the lock step operation, the failures (for example, failures such as routing/arbitration) that could not be repaired by the prior art technology can be repaired.

### Tenth Example

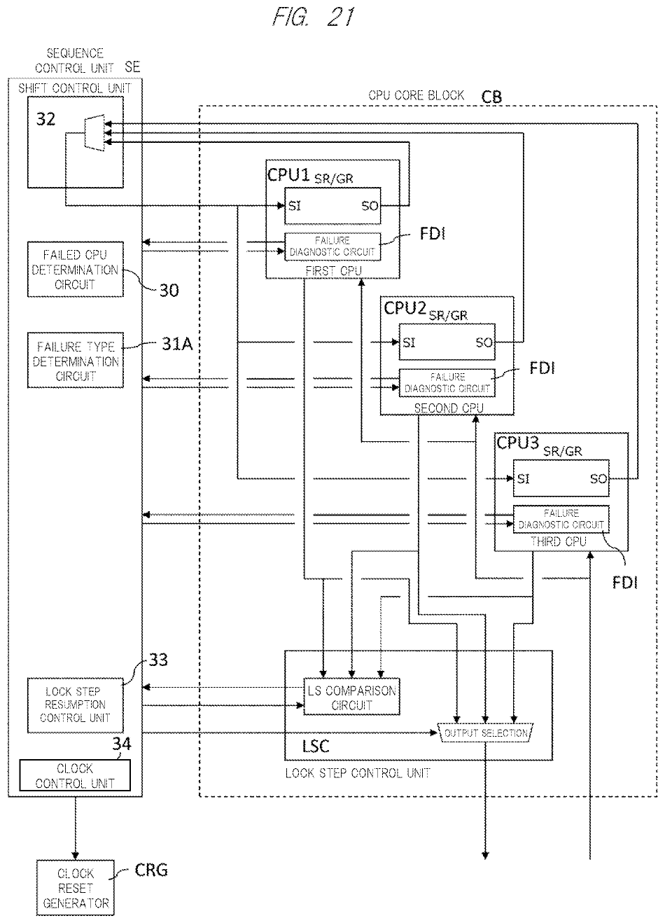

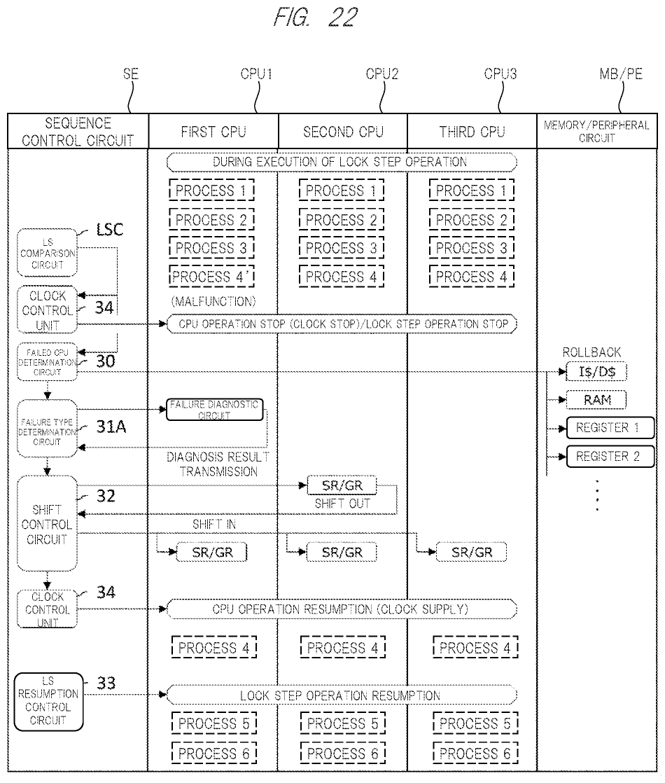

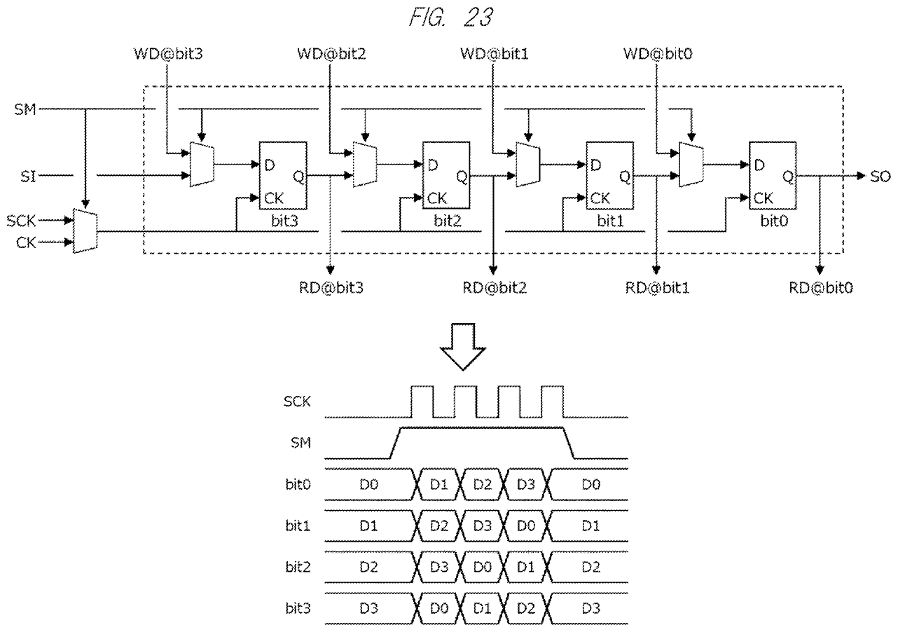

The tenth example illustrates the example in which the targets to be multiplexed in the lock step operation are triplex CPUs (CPU1, CPU2, CPU3). FIG. 21 is an explanatory diagram of a configuration example of a CPU block and a configuration example of a sequence control circuit according to the tenth example. FIG. 22 is an explanatory diagram of an operation of the CPU block and the sequence control circuit in FIG. 21. FIG. 23 is an explanatory diagram of a configuration example and a copy operation of an SR and a GR.

FIG. 21 illustrates a CPU core block CB, a sequence control circuit SE, and a clock reset generator CRG.

A CPU block CB1 includes a first CPU (hereinafter referred to as CPU1), a second CPU (hereinafter referred to as CPU2), a third CPU (hereinafter referred to as CPU3), and a lock step control unit LSC. Each of the CPU1, the CPU2, and the CPU3 has a system register (hereinafter referred to as SR) and a general-purpose register (hereinafter referred to as GR). The value of the GR and the value of the SR can be regarded as the content information held by the CPU core (CPU1, CPU2, or CPU3). The lock step control block LSC is a circuit that performs the lock step comparison operation in the lock step operation.

Each of the CPU1, the CPU2, and the CPU3 includes a serial input port (SI) and a serial output port (SO) for inputting/outputting the held information of the SR and the GR, and a failure diagnostic circuit FDI for determining a failure type.

The sequence control circuit SE is provided to copy the value of the GR and the value of the SR (held information of GR and SR). The clock reset generator CRG generates a clock signal and a reset signal.

The sequence control unit SE includes a failed CPU determination circuit 30 that determines the failed CPU based on the information from the LS comparison circuit of the lock step control block LSC and performs the rollback process, a failure type determination circuit (or failure type diagnostic circuit) 31A that determines the failure type based on the information from the failure diagnostic circuit FDI, a shift control circuit 32 that copies the held information of the SR and the GR from a normal CPU to a failed CPU, a lock step resumption control circuit 33 that controls the timing to resume the lock step (LS) operation, and a clock control circuit 34 that instructs the clock reset generator CRG to stop and resume the clock.

As shown in FIG. 22, it is assumed that the CPU1, the CPU2, and the CPU3, which are performing the lock step operation, execute the process 1, the process 2, the process 3, and the process 4, respectively. The LS comparison circuit of the lock step control block LSC checks the execution of each process, and determines the normal operation and the abnormal operation for each process.

Here, the case in which the CPU1 malfunctions and executes the process 4′ instead of the intended process 4 and the LS comparison circuit detects the abnormal operation and notifies the sequence control unit SE will be described.

When the sequence control unit SE is notified of the abnormal operation, the clock control unit 34 in the sequence control unit SE notifies the clock reset generator CRG of the clock stop, thereby stopping the operations of the CPU1, CPU2, and CPU3. At the same time, the lock step operation is stopped.

When the sequence control unit SE is notified of the abnormal operation, the failed CPU determination circuit 30 in the sequence control unit SE determines the CPU whose abnormal operation has been notified, and executes the rollback process for the memory block MB and the peripheral block PE if necessary. At the same time, the failed CPU determination circuit 30 notifies the failure type determination circuit 31A of the failed CPU information.

When the failure type determination circuit 31A is notified of the failed CPU information, the failure type determination circuit 31A notifies the failure diagnostic circuit FDI of the failed CPU (here, CPU1) of the start of diagnosis.

When the failure diagnostic circuit FDI of the CPU1 is instructed to start diagnosis, the failure diagnostic circuit FDI executes a predetermined test sequence for each functional block in order to determine the SW failure or the HW failure. Then, the failure diagnostic circuit FDI determines the SW failure or the HW failure, and notifies the sequence control circuit SE of the determination result.

When the diagnosis result is the SW failure, the sequence control circuit SE notifies the shift control circuit 32 of the result. When the diagnosis result is the HW failure, the sequence control circuit SE continues the process with only the normal CPU.

Hereinafter, in the tenth example, the operation will be described on the assumption that the diagnosis result is the SW failure.

When the SW failure is notified, the SW failure determination circuit 31 notifies the shift control circuit 32 of the determination result. When the SW failure is notified, the shift control circuit 32 starts the shift control for the system register (SR) and the general-purpose register (GR).

The shift control circuit 32 reads the held information of the system register (SR) and the general-purpose register (GR) from the SO port of the normal CPU (here, CPU2). Thereafter, the read content information is written to the system register (SR) and the general-purpose register (GR) from each SI port of the CPU1, the CPU2, and the CPU3.

FIG. 23 is an explanatory diagram of a configuration example and a copy operation of the SR and the GR. Here, for the sake of simplifying the description, the bit length configuration of the register (SR or GR) is expressed in 4 bits, but the actual bit length of the SR and the GR is configured in 32 bits or 64 bits.

The SR and the GR include a write data (WD) port for writing to the register during normal operation, a read data (RD) port for reading from the register during normal operation, a shift mode (SM) port for controlling the shift operation from the shift control circuit, and an SI port and an SO port for copying the register information.

The shift control circuit 32 sets the SM port to the high level “H”, so that the data input from the SI port is sequentially set to each bit in accordance with the shift clock SCK.

As shown in FIG. 22, when the copying process of the SR and the GR is completed, the shift control circuit 32 notifies the clock control circuit 34 of the completion of copying.

When the completion of copying is notified, the clock control circuit 34 starts supplying the clock CK to the CPU1, the CPU2, and the CPU3.

After starting the clock supply, the LS resumption control circuit 33 resumes the lock step operation by using the dead period (the period in which invalid information is output) information of the lock step comparison. The dead period (the period in which invalid information is output) of the lock step comparison is basically the same as that of the first example.

The first to fifth examples are directed for the duplex modules (CPUs). On the other hand, the tenth example is directed for the triplex modules (CPUs), so that the lock step operation in the multiplex (triplex or higher) modules that are performing the lock step operation can be continued.

In the foregoing, the invention made by the inventors has been specifically described based on the embodiment and the examples, but it goes without saying that the present invention is not limited to the embodiment and the examples described above and can be variously modified.

What is claimed is:

1. A semiconductor device comprising:
a calculation unit including a first CPU and a second CPU that perform a lock step operation; and
a sequence control circuit,
wherein each of the first CPU and the second CPU includes:
a system register (SR) and a general-purpose register (GR);
a replica diagnostic circuit configured to check whether the corresponding CPU is operating correctly;
an input port configured to input held information of the SR and the GR;
an output port configured to output held information of the SR and the GR; and
a self-diagnostic circuit configured to determine a failure type,
wherein the calculation unit includes a lock step control circuit configured to perform a comparison operation in a lock step operation,
wherein the sequence control circuit includes:
a failed CPU determination circuit configured to determine a failed CPU based on information from the replica diagnostic circuit and perform rollback process;
a software (SW) failure determination circuit configured to determine a failure type based on information from the self-diagnostic circuit; and
a shift control circuit configured to copy held information of the SR and the GR of a normal CPU operating normally to the SR and the GR of a failed CPU with a failure, and
wherein when the SW failure determination circuit determines that the failure type of the failed CPU is an SW failure, the sequence control circuit copies the held information of the SR and the GR of the normal CPU, which is one of the first CPU and the second CPU, to the SR and the GR of the failed CPU determined to have the SW failure, which is the other of the first CPU and the second CPU, thereby continuing a process of the lock step operation.

2. The semiconductor device according to claim 1,
wherein when the SW failure determination circuit determines that the failure type of the failed CPU is a hardware (HW) failure, the sequence control circuit stops the failed CPU determined to have the HW failure, which is the other of the first CPU and the second CPU, thereby continuing a process with only the normal CPU, which is one of the first CPU and the second CPU.

3. The semiconductor device according to claim 2,
wherein the sequence control circuit includes a lock step resumption control circuit configured to control a timing to resume the lock step operation, and is configured to determine a signal indicating a valid data output from each of the first CPU and the second CPU and control a start of a comparison operation by the lock step control circuit.

4. The semiconductor device according to claim 2, further comprising:
flip-flop circuits provided on a path between an input of the shift control circuit and the output port and on a path between an output of the shift control circuit and the input port.

5. The semiconductor device according to claim 2,
wherein each of the first CPU and the second CPU includes a first cyclic redundancy check circuit configured to generate error detection information for the held information of the SR and the GR and output the error detection information after adding it to an end of the held information of the SR and the GR, and
wherein the shift control circuit includes a second cyclic redundancy check circuit configured to perform a check with the information of the SR and the GR copied to the failed CPU and the error detection information and notify the sequence control circuit of the result.

6. The semiconductor device according to claim 5, further comprising:
flip-flop circuits provided on a path between an input of the shift control circuit and the output port and on a path between an output of the shift control circuit and the input port.

7. The semiconductor device according to claim 1, further comprising:
a calculation unit including a third CPU and a fourth CPU that perform a lock step operation,
wherein each of the third CPU and the fourth CPU includes:
a system register (SR) and a general-purpose register (GR);
a replica diagnostic circuit configured to check whether the corresponding CPU is operating correctly;
an input port configured to input held information of the SR and the GR;
an output port configured to output held information of the SR and the GR; and
a self-diagnostic circuit configured to determine a failure type, and
wherein when the SW failure determination circuit determines that the failure type of the failed CPU is an SW failure, the sequence control circuit copies the held information of the SR and the GR of the normal CPU, which is one of the first CPU and the second CPU, to the SR and the GR of the failed CPU determined to have the SW failure, which is the other of the first CPU and the second CPU, and to the SRs and the GRs of the third CPU and the fourth CPU, thereby continuing a process of the lock step operation.
